(19) United States
(12) Patent Application Publication
(10) Pub. No.: US 2021/0175960 A1
(43) Pub. Date: Jun. 10, 2021

(54) EXIT SIGN WITH ACCESS CONTROL

(71) Applicant: Hall Labs LLC, Provo, UT (US)

(72) Inventors: David R Hall, Provo, UT (US); Mark Hall, Smithfield, UT (US); John Robinson, Spanish Fork, UT (US); Jerome Miles, Spanish Fork, UT (US)

(73) Assignee: Hall Labs LLC, Provo, UT (US)

(21) Appl. No.: 16/703,842

(22) Filed: Dec. 4, 2019

(51) Int. Cl. H04B 7/15; G08B 5/36; G07C 9/00

(52) U.S. Cl. CPC H04B 7/15; H04L 27/103; G07C 9/00571; G08B 5/36

(57) ABSTRACT

An exit sign that includes an access control point and a system that includes such an exit sign are disclosed. The exit sign includes: a power circuit, a battery that is charged by the power circuit, a light that is powered by at least one of the power circuit and the battery, a sign that is at least partially illuminated by the light, a controller, a wireless radio coupled to the controller, and a relay coupled to the controller and to the actuation device, where the controller controls the relay to actuate the actuation device.

### TECHNICAL FIELD

This disclosure relates to exit signs. In particular, this disclosure relates to exit signs with access control functionality.

### BACKGROUND

Access control devices typically require power and communication wiring that is coupled to a central server. These requirements drastically drive up the cost of adding and installing access control points. Therefore, it would be beneficial to improve the way access control points are added so as to reduce the cost of adding and installing access control points.

### SUMMARY [IN LANGUAGE CONSISTENT WITH CLAIMS]

In a first aspect, the disclosure describes an exit sign, that includes a power circuit; a battery that is charged by the power circuit; a light that is powered by at least one of the power circuit and the battery; a sign that is at least partially illuminated by the light; a controller; and a relay coupled to the controller, where the controller controls operation of the relay.

In a second aspect, the disclosure describes that the controller provides a wired communication interface. The disclosure further describes that the wired communication interface is a Weigand interface.

In a third aspect, the disclosure describes that the exit sign includes a first wireless radio coupled to the controller, wherein the first wireless radio communicates using the 902 MHz to 928 MHz frequency band, wherein the first wireless radio utilizes a first radio access technology (RAT), and wherein the first RAT uses chirp modulation.

In a fourth aspect the disclosure describes that the controller is adapted to bridge the Weigand interface with a second Weigand interface (at a central server, for example) using the first RAT.

In a fifth aspect, the disclosure describes that the exit sign includes a second wireless radio coupled to the controller, wherein the second wireless radio communicates using the 2400 MHz to 2483.5 MHz frequency band, wherein the second wireless radio utilizes a second radio access technology (RAT) that is different than the first RAT, and wherein the second RAT uses at least one of orthogonal frequency division multiplexing (OFDM), orthogonal frequency division multiple access (OFDMA), frequency-hopping spread spectrum (FHSS), and adaptive frequency-hopping spread spectrum (AFH).

In a sixth aspect, the disclosure describes that the relay includes a low-power circuit and a high-power circuit.

In a seventh aspect, the disclosure describes that the low-power circuit of the relay is powered by at least one of the power circuit and the battery.

In an eighth aspect, the disclosure describes that the high-power circuit of the relay is powered by the battery.

In a ninth aspect, the disclosure describes that the controller is powered by at least one of the power circuit and the battery.

In a tenth aspect, the disclosure describes a system for secure access that includes a door; an actuation device that secures the door; an exit sign, that includes: a power circuit; a battery that is charged by the power circuit; a light that is powered by at least one of the power circuit and the battery; a sign that is at least partially illuminated by the light; a controller; a wireless radio coupled to the controller; and a relay coupled to the controller and to the actuation device, wherein the controller controls the relay to actuate the actuation device.

In an eleventh aspect, the disclosure describes that the controller provides a wired communication interface. The disclosure further describes that the wired communication interface is a Weigand interface.

In a twelfth aspect, the disclosure describes that the system further includes an input device, wherein the input device communicates with the controller via the wired communication interface.

In a thirteenth aspect, the disclosure describes that the input device is a keypad.

In a fourteenth aspect, the disclosure describes that the input device is a radio-frequency identifier (RFID) reader.

In a fifteenth aspect, the disclosure describes that the system further includes a server that manages access control, wherein the controller receives an input from the input device via the wired communication interface and communicates the input to the server via the wireless radio, wherein the server authorizes access based on the received input and communicates a command to the controller via the wireless radio to actuate the actuation device, and wherein the controller controls the relay to actuate the actuation device.

In a sixteenth aspect, the disclosure describes that the server comprises a third wireless radio and a second communication interface, and wherein the wireless radio and the third wireless radio form a wireless bridge that unifies the communication interface and the second communication interface into a single communication interface.

In a seventeenth aspect, the disclosure describes that the wireless radio communicates using the 902 MHz to 928 MHz frequency band.

In an eighteenth aspect, the disclosure describes that the exit sign further comprises a second wireless radio coupled to the controller, wherein the wireless radio utilizes a first radio access technology (RAT) and the second wireless radio utilizes a second radio access technology, and wherein the first RAT uses chirp modulation and the second RAT uses at least one of orthogonal frequency division multiplexing (OFDM), orthogonal frequency division multiple access (OFDMA), frequency-hopping spread spectrum (FHSS), and adaptive frequency-hopping spread spectrum (AFH).

In a nineteenth aspect, the disclosure describes that the controller is powered by at least one of the power circuit and the battery.

In a twentieth aspect, the disclosure describes that the relay comprises a low-power circuit and a high-power circuit, and wherein the high-power circuit is powered by the battery.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIGS. 1A and 1B are perspective views that illustrate an exemplary environment in which the described systems, devices, and methods may be implemented.

FIG. 2 is a block diagram illustrating one embodiment of an exit sign.

FIG. 3 is a block diagram illustrating one example of the interior of an exit sign.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

### Description

Access control has traditionally been accomplished through the use of mechanical locks and physical keys. The introduction of digital access systems with electronically actuated locks and digital keys (e.g., tokens, passcodes, etc.) provides several benefits over mechanical locks and physical keys, including user specific keys that can be easily enabled and disabled through an access management system, and electronic logging and tracking. Accordingly, digital access systems are desirable.

One of the challenges associated with digital access systems is the need to provide both electrical power and control system wiring to each access control point (e.g., door, entry/exit point). Wireless control wiring systems, such as those produced by Sure-Fi, Inc., have eliminated the need to run physical control wires between the central controller and each access control point. Electrical power, however, must still be supplied to each access control point to power the electrical components (e.g., electronic actuator, controller, relay, wireless radios, keypad, and the like) needed to implement and enable the access control point. Typically, the cost of bringing electrical power to the access control point represents the greatest single expense in implementing digital access control at a door. Accordingly, solutions for reducing the cost of providing power to the access control point are desired.

Regulatory requirements typically mandate the placement of exit signs in close proximity to doorways. As described herein, an access control point may be powered by the electrical power supplying an exit sign and/or a battery within the exit sign. In some embodiments, the access control point may be substantially implemented within an exit sign with only those devices, such as the electronic actuator and/or the keypad, which are required to be located outside of the exit sign, being external to the exit sign. These external devices, however, are wired to the access control point within the exit sign.

For example, a typical exit sign may be easily removed and replaced with an exit sign that includes a built-in access control point. In such an example, electrical power is drawn from the existing power source that powered the typical exit sign. In this way, the access control point may be easily powered without running any new power wires. It is appreciated that any external devices, such as the electronic actuator and/or an input device (e.g., keypad, RFID reader, and the like) are wired (using low voltage wire, for example) directly to the access control point (e.g., controller)within the exit sign. Therefore, an access control point may easily be installed by a door by replacing the exiting exit sign with the described exit sign and wiring up the electronic actuator and/or the keypad directly to the exit sign. Because no new high voltage (e.g., 120 volt, 277 volt) power wires need to be run for installation, the installation of the described exit sign and the low voltage wiring of the electronic actuator and/or the input device may be performed by a person who is not a qualified electrician, which both simplifies and reduces the cost of installation.

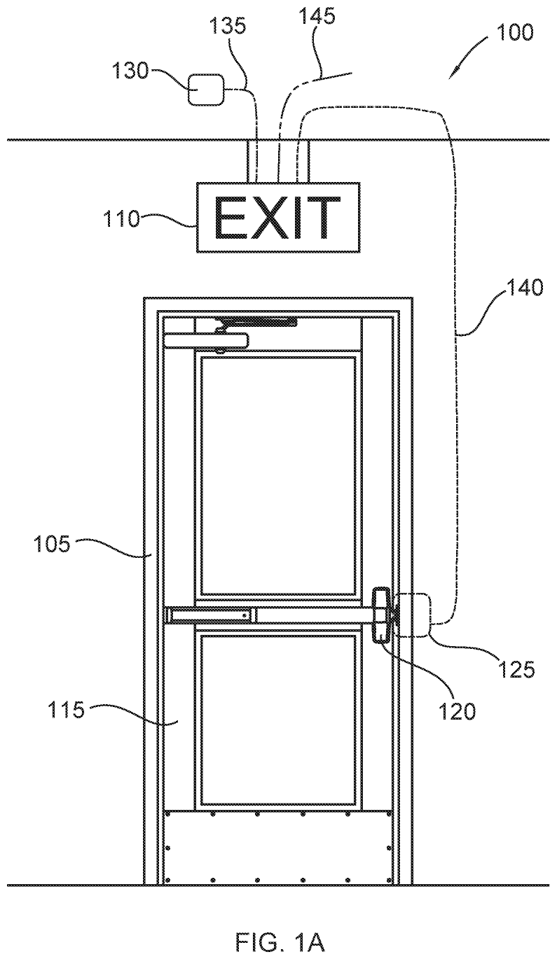

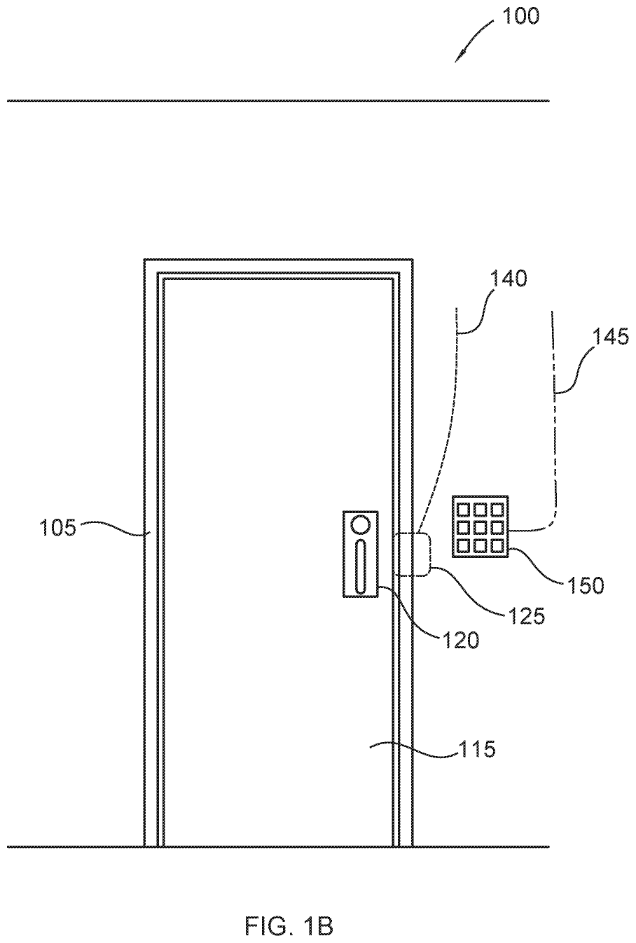

Now referring to the Figures, FIGS. 1A and 1B illustrate an exemplary environment 100 in which the described systems, devices, and methods may be implemented. Environment 100 includes a doorway 105 and a door 115 that provides an entry/exit between an inside of a building, as illustrated in FIG. 1A and an outside of a building, as illustrated in FIG. 1B. The door 115 may include operating hardware 120 for manual operation (e.g., opening, closing, locking, unlocking). In one example, as illustrated, the operating hardware 120 on the inside (e.g., FIG. 1A) of the door 115 comprises a push bar exit device while the operating hardware 120 on the outside (e.g., FIG. 1B) of the door 115 comprises a key lock and a pull handle.

As illustrated in FIG. 1A, an exit sign 110 is mounted in close proximity to the doorway 105 (mounted to the ceiling above the doorway 105, as shown, for example) to indicate that the doorway 105 is an exit (that leads to the outside, for example). As with typical exit signs, the exit sign 110 is connected to a power source 130 (that provides 120 volts, or 277 volts of alternating current (AC) power, for example) through power wiring 135. The power source 130 and the power wiring 135 may have been installed previously for powering a typical exit sign (that does not include an access control point, and only includes power circuitry, a battery, and a light for illuminating the exit sign, for example). The exit sign 110 includes an access control point.

The access control point within the exit sign 110 includes a control interface (e.g., a relay) for controlling an electronic actuator 125 via control wiring 140. In one example, the electronic actuator 125 (e.g., strike lock, electromagnetic lock, and the like) has a default state (e.g., normally closed/locked/fail-secure, or normally open/unlocked/fail-safe)when the control interface provides no voltage (e.g., an open circuit) to the electronic actuator via the control wiring 140 and has an actuated state (e.g., unlocked if the default state is locked, or locked if the default state is unlocked) when the control interface supplies low voltage (e.g., 12V DC, 24V DC) to the electronic actuator 125 via the control wiring 140.

The access control point within the exit sign 110 also includes a communication interface (e.g., a Weigand interface) for communicating with an input device (e.g., input device 150) via communication wiring 145. As illustrated in FIG. 1B, the input device 150 communicates with the access control point through a communication interface via the communication wiring 145. Similarly, the electronic actuator is controlled by the access control point through the control interface via the control wiring 140.

By way of example, a person seeking to enter through the doorway 105 may provide an identifier via the input device 150. In the case that the input device 150 is an RFID reader, the person may wave an RFID tag near the input device 150 and the identifier is provided by the RFID tag. In the case that the input device 150 is a keypad, the person may enter a code (e.g., 4-digit, 6-digit passcode) into the input device 150 and the code is the identifier. The identifier is provided to the communication interface of the access control point in the exit sign 110 via the communication wiring 145. Continuing with the example, the access control point may compare the identifier with a local database of permitted identifiers or may communicate the identifier to a central server of the access control system for verification of authorized users. In some cases, the access control point may provide a first communication interface (e.g., Weigand interface) that is coupled to the input device 150 via the communication wiring 145 and may provide a second communication interface (e.g., Weigand interface) that is coupled to a wireless radio and wirelessly bridged to a communication interface coupled to the central server.

Continuing with this example, the central server may indicate (via the second communication interface, for example) that the identifier is authenticated and that the access control point should actuate the electronic actuator 125. Upon receiving this information from the central server, the access control point may use the control interface to control the electronic actuator 125 via the control wiring 130 to actuate for a predetermined amount of time (sufficient time to allow the person to pull the handle and enter through the door, for example). Accordingly, the inclusion to an access control point within an exit sign 110 simplifies the installation process by using a preexisting power source (e.g., power source 130) and simplifies the installation by packaging everything but the external devices (e.g., the electronic actuator 125 and the input device 150) into the exit sign 110.

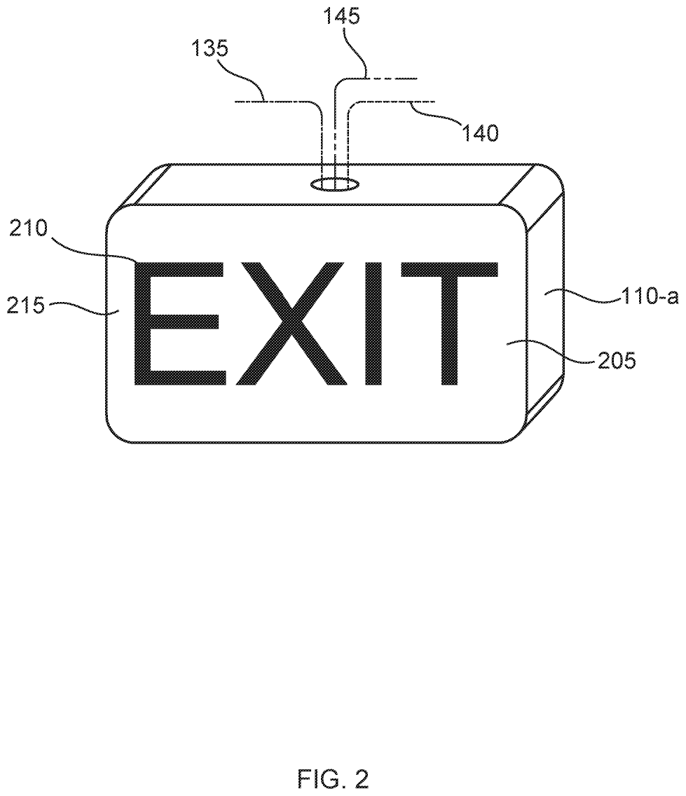

FIG. 2 is a block diagram illustrating one embodiment of an exit sign 110-a. The exit sign 110-a may be an example of the exit sign 110 discussed with respect to FIGS. 1A and 1B. In some embodiments, the exit sign 110-a includes a power interface for receiving electrical power via the power wiring 135, a communication interface for receiving communications via the communication wiring 145, and a control interface for providing control information via control wiring 140.

The exit sign 110-a includes at least one sign plate 205. In some embodiments, the sign plate 205 is substantially an entire side of the exit sign 110-a. Often, the sign plate is removable and or interchangeable for configuring the sign plate 205 to point (e.g., with arrows) towards the doorway and/or for access to internals of the exit sign 110-a (for installing and mounting the exit sign 110-a, for example).

It is appreciated that exit signs may have a single sign plate 205 on one side when it is providing a line of sight to a single direction (as is the case when the exit sign 110-a and the sign plate 205 are parallel to the exit doorway, as illustrated in FIG. 1A, for example) and may have a sign plate 205 on two sides when it is providing a line of sight to two different directions (as is the case when the exit sign 110-a and the two sign plates are perpendicular to the exit doorway, for example).

The sign plate 205 may include two contrasting (e.g., opaque/translucent, green/white, non-lighted/lighted) areas such as areas 210 and 215. In some embodiments, area 210 is translucent (allowing light from inside the exit sign 110-a to illuminate the area 210, for example) and area 215 is opaque (not allowing light from inside the exit sign 110-a to pass through the area 215, for example). In other embodiments, area 210 is translucent white (allowing white light from inside the exit sign 110-a to illuminate the area 210, for example) and area 215 is translucent green (allowing green light from inside the exit sign 110-a to pass through the area 215, for example).

In some embodiments, the power wiring 135, may be pigtail wires that may be coupled to power carrying wires from the power source (e.g., power source 130). In some embodiments, exit sign 110-a includes a control interface that includes physical connectors (e.g., terminal connections such as screw terminals) to which the control wiring 140 may be attached. In some embodiments, the control wiring 140 may be coupled to the exit sign 110-a during installation. Similarly, in some embodiments, exit sign 110-a includes a communication interface (e.g., Weigand interface) that includes physical connectors (e.g., terminal connections such as screw terminals) to which the communication wiring 145 may be attached. In some embodiments, the communication wiring 145 may be coupled to the exit sign 110-a during installation.

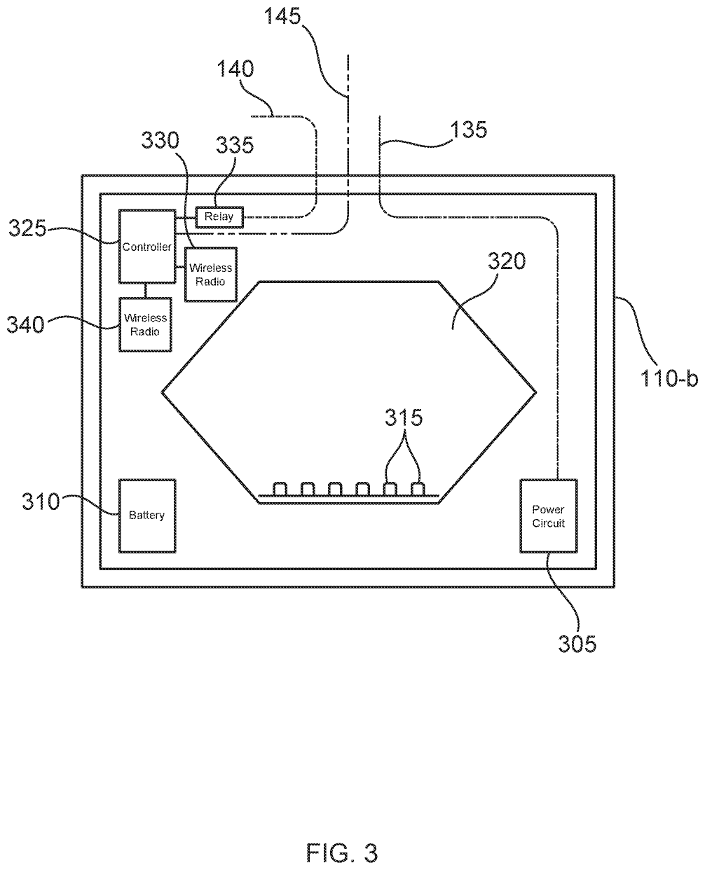

FIG. 3 is a block diagram illustrating one example of the interior of an exit sign 110-b. Exit sign 110-b is an example of the exit signs 110, 110-a illustrated in FIGS. 1A, 1B, and 2. For example, exit sign 110-b may be the exit sign 110-a of FIG. 2 with the sign plate 205 removed to expose the internals of the exit sign 110-a.

The exit sign 110-b includes a power circuit 305, a battery 310, one or more lights 315 (for illuminating a translucent are of a sign plate (e.g., sign plate 205), for example), and a light illumination area 320. As described herein, the exit sign 110-b may additionally include an access control point, which includes a controller 325, a first wireless radio 330, a relay 335, and a second wireless radio 340.

In typical operation, the power circuit 305 powers the one or more lights 315 and charges the battery 310. Because it is important for the one or more lights 315 to illuminate the exit sign 110-b when the power is out (the power circuit 305 is not receiving any power from a power source (e.g., power source 130) the battery 310 provides backup power and powers the one or more lights 315 when the power is out.

The power circuit 305 may be adapted (e.g., sized larger) to power both the one or more lights 315 and the access control point. Additionally, or alternatively, the power circuit 305 may be adapted (e.g., sized larger) to charge a larger/bigger capacity battery 310. The power circuit 305 may convert high voltage (e.g., 120 volts, 277 volts) from a power source to low voltage (e.g., 12 volts, 24 volts) for powering the exit sign 110-b.

The battery 310 may store power for powering the exit sign 110-b (including any or all of its components, for example) when the power supply 305 is not receiving power from a power source. In addition to powering the components (e.g., the controller 325, the first wireless radio 330, the relay 335(e.g., the low-power side of the relay 335), the second wireless radio 340) of the access control point, the battery 310 is sized to power multiple (e.g., at least 3, at least 5, at least 10) actuations of an electronic actuator (e.g., electronic actuator 125) via the relay 335 (e.g., the high power side of the relay 335). It is appreciated that the power consumption of the components within the exit sign 110-b may be comparatively small compared to the power consumption required to actuate an electronic actuator.

In some embodiments, the battery 310 may include two (2) batteries, with a first battery 310 being dedicated to providing backup power to the one or more lights 315 (the traditional function of the battery for an exit sign, for example) with a second battery 310 being dedicated to powering the access control point as well as multiple actuations of an electronic actuator. In some cases, the access control point and/or an electronic actuator may only be powered by a battery 310 (as in the case where the power source to the power circuit is current limited, low voltage (e.g., 12 volts, 24 volts), for example). In other cases, the access control point and/or an electronic actuator may be powered by the power circuit 305 with the battery 310 providing backup power when the power source is unavailable (e.g., the power is out, or is unavailable for a test mode). In some embodiments, the access control point and/or an electronic actuator may be powered exclusively by the battery 310 (with the battery 310 being replenished by trickle charging when a power source is available to the power circuit 305, for example).

The one or more lights 315 may illuminate the exit sign 110-b so that it can easily be identified (and used to direct people towards/through an exit, for example). Often the one or more lights 315 are light emitting diodes (LEDs), however any light emitting device may be used that suits the purpose of illuminating a light illumination area 320, for illuminating at least a portion of a sign plate (e.g., sign plate 205) of the exit sign (as illustrated in 110-a, for example). The light illumination area 320 may be an enclosed area that focus and contain the light from the one or more lights 315 to the desired light illumination area 320 corresponding to the translucent portions (e.g., area 210) of the sign plate (e.g., sign plate 205).

The controller 325 may implement the access control point functions. The controller 325 includes a processor and memory for storing instructions that are executable by the processor. Examples of the processor include a general processor, application specific integrated circuit (ASIC), field programmable gate array (FPGA), and the like. The controller 325 includes multiple input/output ports, including output ports for controlling the relay 335, input/output ports for communicating with the first wireless radio 330 and the second wireless radio 340, and input/output ports for implementing a communication interface (e.g., a Weigand interface) for communicating over communication wiring 145.

The first wireless radio 330 may be configured to send and receive wireless communications using a first radio access technology (RAT). Examples of the first RAT may be Wi-Fi, LoRaWAN, chirp spread spectrum (CSS), chirp modulation, and chirp division multiplexing. In some embodiments, the first RAT may be an intermediate range wireless communication protocol that uses chirp modulation and operates in the 902 MHz-928 MHz frequency band.

In some embodiments, the controller 325 converts the communication interface implemented by the controller 325 to wireless communications via the first wireless radio 330. In this way the access control point acts as one end of a wireless bridge that in combination with a second end of the wireless bridge (at the central server, for example) provides wirelessly enabled communication interface between the access control point and a central server that manages access control. This wireless bridge may enable the exit sign 110-b with the access control point to be installed anywhere within communication range without running physical communication wires between the central server and the access control point.

The relay 335 may have a low-power side that controls switching of a high-power side. The low-power side of the relay 335 is coupled to and controlled by the controller 325. The high-power side of the relay 335 may be connected (when installed, for example) to an electronic actuator and provides the power required to actuate the electronic actuator. The relay 335 may be normally open or normally closed. In a preferred embodiment, the relay 335 is normally open to reduce power consumption when not actuated and closed to connect the electronic actuator to a power supply (e.g., the power circuit 305 and/or the battery 310) to actuate the electronic actuator.

The second wireless radio 340 may be configured to send and receive wireless communications using a second radio access technology (RAT) that is different than the first RAT. Examples of the second RAT may be Wi-Fi or Bluetooth. In some embodiments, the second RAT may be used to configure the access control point, such as providing configuration settings for communicating with second end of a wireless bridge. In other embodiments, the second RAT may be used to provide Wi-Fi or Bluetooth access (as a Wi-Fi or Bluetooth access point, for example). For example, two or more exit signs (e.g., exit sign 110) may interconnect and/or create a Bluetooth mesh network. Continuing with this example, the second wireless radio 340 in combination with one or more other described exit signs may enable Internet of Things (IoT) control of the access control points and/or may facilitate a high availability (due to large number and ideal positioning of exit signs, for example) network for IoT device (e.g., light bulbs, light switches, blinds, thermostats, sensors, and the like) management and/or control.

In one exemplary embodiment, a person seeking entry into a building through doorway 105 and door 115 may enter a code via user input 150 (e.g., keypad). The code is communicated to the controller 325 via the communication wiring 145 (using Weigand protocol, for example). The controller 325 in combination with the first wireless radio, converts the wired communication interface (e.g., communication wiring 145) into wireless communication signals and transmits the wireless communication signals over the 902 MHz to 928 MHz frequency band using chirp modulation. A complementary bridging device receives the wireless communication signals and converts the wireless communication signals back to a wired communication interface that is coupled to a central server.

The central server that manages access control compares the code with a set of access control parameters. If the code is not authorized for access, the central server may send an indication of denial to the user input device 150 via the wireless bridge created in part by the controller 325 and the first wireless radio 330. If, on the other hand, the code is authorized for access, the central server may send a command via the wireless bridge to the controller 325 to actuate the electronic actuator 125. Upon receiving the command to actuate the electronic actuator 125, the controller 325 may control the relay 335 to close the high power side of the relay to complete a circuit between the power circuit 305 and/or the battery 310 (depending on where power may be drawn from, for example) and the electronic actuator 125 to actuate the electronic actuator 125. In one example, the electronic actuator 125 is an electric strike lock that allows the door 115 to be opened when the electric strike lock is actuated. In one example, the electric strike lock may be actuated for a few second to enable the person to open the door and enter the building.

In some embodiments, the controller 325 may communicate that the electric strike lock was actuated for the time period that it was actuated. After a predetermined time or upon detection that the door 115 is opened, the controller 325 may control the relay 335 to open the high power side of the relay 335 so that the circuit between the power source and the electric strike lock is broken and the electric strike lock returns to its default state (e.g., locked).

With the wireless bridge in place for extending communication wiring to the access control point (and to the input device 150, for example) only power is needed to add electronic access control to a doorway 105. Since exit signs are positioned in close proximity to doorways 105 and since exit signs are already wired with power, an exit sign with an access control point built, as described herein, may easily be installed by installing the exit sign 110 and wiring up the electronic actuator 125 via control wiring 140 and/or wiring up an input device 150 via communication wiring 145. Accordingly, an access control point may be added in a simpler and cheaper way than running power wiring and/or communication wiring from a central server to the access control point as well as wiring up the electronic actuator 125 and/or input device 150.

The invention has been described with reference to various specific and preferred embodiments and techniques. Nevertheless, it is understood that many variations and modifications may be made while remaining within the spirit and scope of the invention.

What is claimed is:

1. An exit sign, comprising:
a power circuit;
a battery that is charged by the power circuit;
a light that is powered by at least one of the power circuit and the battery;
a sign that is at least partially illuminated by the light;
a controller; and
a relay coupled to the controller, wherein the controller controls operation of the relay.

2. The exit sign of claim 1, wherein the controller provides a wired communication interface, and wherein the wired communication interface comprises a Weigand interface.

3. The exit sign of claim 2, further comprising:
a first wireless radio coupled to the controller, wherein the first wireless radio communicates using the 902 MHz to 928 MHz frequency band, wherein the first wireless radio utilizes a first radio access technology (RAT), and wherein the first RAT uses chirp modulation.

4. The exit sign of claim 3, wherein the controller is adapted to bridge the Weigand interface with a second Weigand interface using the first RAT.

5. The exit sign of claim 3, further comprising:
a second wireless radio coupled to the controller, wherein the second wireless radio communicates using the 2400 MHz to 2483.5 MHz frequency band, wherein the second wireless radio utilizes a second radio access technology (RAT) that is different than the first RAT, and wherein the second RAT uses at least one of orthogonal frequency division multiplexing (OFDM), orthogonal frequency division multiple access (OFDMA), frequency-hopping spread spectrum (FHSS), and adaptive frequency-hopping spread spectrum (AFH).

6. The exit sign of claim 1, wherein the relay comprises a low-power circuit and a high-power circuit.

7. The exit sign of claim 6, wherein the low-power circuit of the relay is powered by at least one of the power circuit and the battery.

8. The exit sign of claim 6, wherein the high-power circuit of the relay is powered by the battery.

9. The exit sign of claim 1, wherein the controller is powered by at least one of the power circuit and the battery.

10. A system for secure access, comprising:
a door;
an actuation device that secures the door;
an exit sign, comprising:
a power circuit;
a battery that is charged by the power circuit;
a light that is powered by at least one of the power circuit and the battery;
a sign that is at least partially illuminated by the light;
a controller;
a wireless radio coupled to the controller; and
a relay coupled to the controller and to the actuation device, wherein the controller controls the relay to actuate the actuation device.

11. The system of claim 10, wherein the controller provides a wired communication interface, and wherein the wired communication interface comprises a Weigand interface.

12. The system of claim 11, further comprising:
an input device, wherein the input device communicates with the controller via the wired communication interface.

13. The system of claim 12, wherein the input device comprises a keypad.

14. The system of claim 12, wherein the input device comprises a radio-frequency identifier (RFID) reader.

15. The system of claim 12, further comprising:
a server that manages access control, wherein the controller receives an input from the input device via the wired communication interface and communicates the input to the server via the wireless radio, wherein the server authorizes access based on the received input and communicates a command to the controller via the wireless radio to actuate the actuation device, and wherein the controller controls the relay to actuate the actuation device.

16. The system of claim 15, wherein the server comprises a third wireless radio and a second communication interface, and wherein the wireless radio and the third wireless radio form a wireless bridge that unifies the communication interface and the second communication interface into a single communication interface.

17. The system of claim 10, wherein the wireless radio communicates using the 902 MHz to 928 MHz frequency band.

18. The system of claim 10, wherein the exit sign further comprises a second wireless radio coupled to the controller, wherein the wireless radio utilizes a first radio access technology (RAT) and the second wireless radio utilizes a second radio access technology, and wherein the first RAT uses chirp modulation and the second RAT uses at least one of orthogonal frequency division multiplexing (OFDM), orthogonal frequency division multiple access (OFDMA), frequency-hopping spread spectrum (FHSS), and adaptive frequency-hopping spread spectrum (AFH).

19. The system of claim 10, wherein the controller is powered by at least one of the power circuit and the battery.

20. The system of claim 10, wherein the relay comprises a low-power circuit and a high-power circuit, and wherein the high-power circuit is powered by the battery.
